(19) United States
(12) Patent Application Publication
(10) Pub. No.: US 2014/0145963 A1
(43) Pub. Date: May 29, 2014

(54) METHOD OF CUSTOM-DEFINED FUNCTIONS OF INPUT DEVICE AND ELECTRONIC DEVICE USING THE SAME

(71) Applicant: ASUS TECHNOLOGY PTE LTD, Eightrium (SG)

(72) Inventors: Yun-Feng YAN, Eightrium (SG); Lin-Yan YANG, Eightrium (SG)

(73) Assignee: ASUS TECHNOLOGY PTE LTD, Eightrium (SG)

(21) Appl. No.: 14/085,240

(22) Filed: Nov. 20, 2013

Related U.S. Application Data
(60) Provisional application No. 61/729,533, filed on Nov. 23, 2012.

(30) Foreign Application Priority Data
Oct. 25, 2013 (TW) 102138807

(51) Int. Cl. G06F 3/023

(52) U.S. Cl. CPC G06F 3/0238
USPC 345/172

(57) ABSTRACT

A method of custom-defined functions of an input device is provided, and it is applied to an electronic device. The electronic device includes a virtual input interface and an input device. The input device includes at least one input key. The method includes following steps: custom-defined setting information of the input keys via the virtual input interface; saving the setting information of the input keys to the basic input/output system (BIOS) of the electronic device, and updating a setting information database in accordance with the input device; wherein when the updated setting information database is read and the input key is activated, a setting function in accordance with the setting information is executed.

### CROSS-REFERENCE TO RELATED APPLICATION

This application claims the priority benefit of U.S. provisional application Ser. No. 61/729,533, filed on Nov. 23, 2012 and TW application serial No. 102138807, filed on Oct. 25, 2013. The entirety of the above-mentioned patent application is hereby incorporated by reference herein and made a part of specification.

### BACKGROUND OF THE INVENTION

1. Field of the Invention

The invention relates to a method of custom-defined functions of an input device and an electronic device using the same.

2. Description of the Related Art

Although the technology of a touch control display device develops rapidly, keyboards are still frequently used in electronic devices (such as a desktop computer or a personal notebook computer).

Conventionally, keyboards are coupled to a processing unit of the electronic device via a keyboard controller. When a press key of the keyboard is activated, the keyboard controller disposed in the keyboard or the motherboard of the electronic device determines which press key is activated according to the position of the activated switch. For example, while a key of the keyboard is activated, a scan code of the key is transmitted via the operation system to send the information of the keyboard to the application program, and an application program of the electronic device to control and read a signal inputted by the keyboard is enabled.

However, as the electronic device (such as a notebook computer) becomes smaller and lighter, some additional functions of the electronic device, such as image display switch between a screen and a projector, volume or luminance adjustment switch, are integrated to the keys. In other words, one press key may represent multiple functions. Conventionally, a user usually presses a function key (Fn key) and an alphabet key at the same time to enable the additional functions.

However, when press keys are damaged, the whole electronic device needs to be sent back to the manufacturer for repairing since the keyboard is usually integrated with the electronic device, which costs time and money.

### BRIEF SUMMARY OF THE INVENTION

A method of custom-defined functions of an input device applied to an electronic device is provided. The electronic device includes a virtual input interface and an input device, and the input device includes at least one input key.

The method of custom-defined functions of an input device includes following steps: defining setting information of the input keys via the virtual input interface; and saving the setting information of the input keys to a basic input/output system (BIOS) of the electronic device, and updating a setting information database in accordance with the input device; wherein when the updated setting information database is read and the input key is activated, a setting function in accordance with the setting information is executed.

An electronic device which defines an input function is also provided. The electronic device includes an input device, a setting unit, a storage unit and an executing unit. The storage unit is electrically connected to the executing unit and the setting unit, respectively.

The input device includes at least one input key. The setting unit defines setting information of the input key and generates a setting information signal. The storage unit is electrically connected to the setting unit to receive the setting information signal, and updates a setting information database in the storage unit in accordance with the input device according to the setting information signal.

When the input key is activated, the executing unit reads the updated setting information database and executes a setting function in accordance with the setting information, and the setting information database is saved in a BIOS.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a virtual input interface provided by an electronic device in an embodiment;

FIG. 2 is a flow chart showing a method of custom-defined functions of an input device in an embodiment; and

FIG. 3 is a block diagram showing a system which can define functions of an input device in an embodiment.

### DETAILED DESCRIPTION OF THE EMBODIMENTS

Steps of a method of custom-defined functions of an input device are illustrated with relating figures. The same symbols denote the same steps and components, and unrelated steps are omitted.

An electronic device hereinafter may be a desktop computer, a Barebone or a portable computer. The portable computer includes a notebook computer, a tablet computer, a palmtop computer, an ultra-mobile personal computer (UMPC), an electronic dictionary and a personal digital assistant (PDA). In the embodiment, an input device is a keyboard, which is not limited.

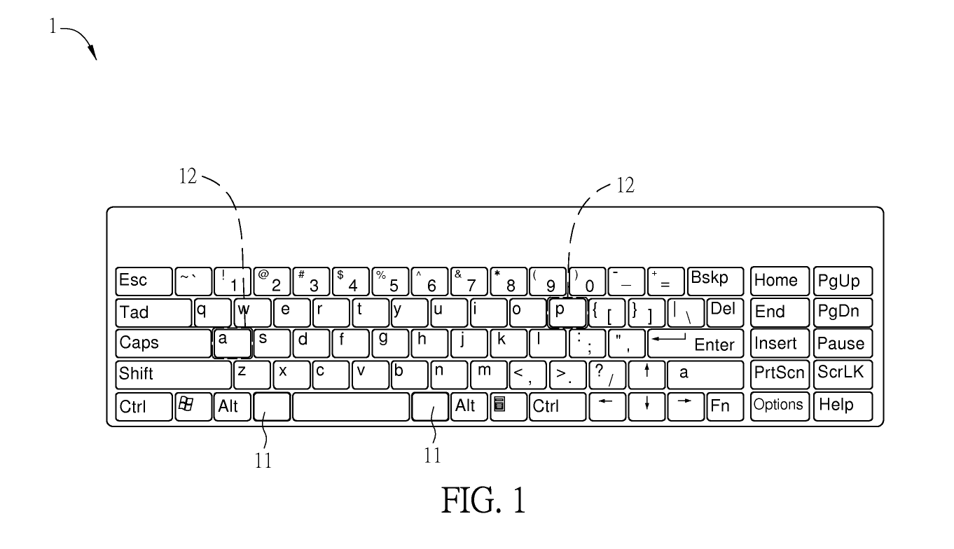

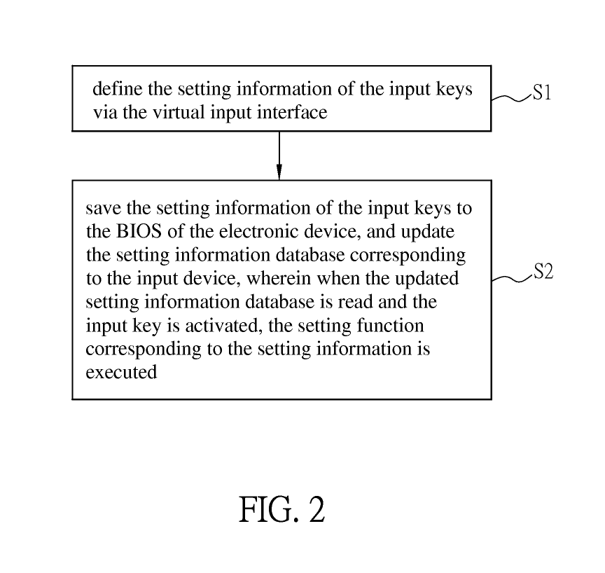

FIG. 1 is a schematic diagram showing a virtual input interface provided by an electronic device in an embodiment, and FIG. 2 is a flow chart showing a method of custom-defined functions of an input device in an embodiment.

Please refer to FIG. 1, the electronic device in the embodiment at least includes a virtual input interface and an input device. The input device 1 includes at least one input key, and the input key may be a null key 11 or a press key 12 (only two press keys are shown in FIG. 1). In the embodiment, the input device 1 includes two null keys 11 disposed beside a space key, respectively. The disposing positions and number of the null keys 11 are not limited herein. At an original state, the setting information of the null key is null, but each of other press keys 12 equips an original setting function in accordance with original setting information. The setting information and the original setting information are scan codes.

The press key 12 may be an alphanumeric key, a function key or an Fn key. The alphanumeric key may include alphabet keys “a” to “z”, number keys “0” to “9”, a Ctrl key, a Shift key and an Alt key, and the function key may include keys “F1” to “F12”.

The input device 1 further includes a keyboard controller (not shown) disposed in the keyboard or the motherboard of the electronic device to detect whether the null key 11 or the press key 12 is activated.

Each input key of the input device 1 has a corresponding switch which is coupled to the keyboard controller. The keyboard controller scans the switches at a constant time interval and determines whether one or more input keys are activated, so as to transmit a keyboard signal to the keyboard controller. Then, the keyboard controller matches the corresponding setting information according to different keyboard signals of the input keys. The setting information of the input device 1 is determined by the type of the keyboard, which is not enumerated herein.

In the embodiment, the input device 1 is a keyboard. The virtual input interface includes a virtual keyboard, and the virtual input keys of the virtual keyboard are configured in accordance with the input keys of the input device. In an embodiment, the input device 1 is configured to the electronic device, when the user enables the virtual input interface of the electronic device, the virtual input interface directly displays a virtual keyboard whose configuration is the same as that of the input device 1, and the user can operate intuitively. However, if the physical input device 1 is coupled to the electronic device by demand (which means the physical input device is not always connect to the electronic device), the layout of the input device 1 can be displayed by selecting a type of the input device at the virtual input interface or automatically selecting via a driver of the input device.

Please refer to FIG. 2, the method of custom-defined functions of an input device includes: defining the setting information of the input key via the virtual input interface (step S1). The input key is the null key 11 or the press key 12, and the setting information is defined to designate the null key 11 or the press key as one of alphanumeric keys.

In the embodiment, the null key 11 is set to act as the alphabet press key “P” to replace the damaged press key “P”. In operation, the user can click the press key “P” at the virtual keyboard, and drag the press key “P” to the null key 11 at the virtual keyboard to finish the setting. The user also can double-click the press key “P” at the virtual keyboard, and a dialog box popped up from the virtual input interface to inquire the user whether to set the null key as the selected press key. If the user clicks “yes”, the setting is finished, which is not limited herein.

Taking the press key 12 as an example, the user can adjust the configuration of the press keys at the physical keyboard according to the using habit. For example, the positions of two alphabet press keys 12 may be exchanged. The user can click the press key “P” at the virtual keyboard, and drags it to the position of the press key “A” at the virtual keyboard to finish the setting, which is not limited herein. Furthermore, the number of the press keys which can be set in the step S1 is not limited to two. In another embodiment, the user can set the configuration of the whole keyboard by himself or herself to meet different requirements.

The null key 11 or any one of the press keys 12 can be set as a function key besides an alphanumeric key. In other words, the setting information can make the null key 11 or a press key 12 act as any function key. The setting function of the function key includes one of power control, status control, volume adjustment, backlight adjustment and display image switch. Thus, after setting, the null key 11 or one press key 12 can directly enable or disable the power control of the electronic device, control the electronic device to enter a sleep mode or a standby mode, adjust the volume (for example, one null key turns up the volume, and the other null key turns down the volume), turn on or turn off the backlight of a display screen of the electronic device and switch the display image of the electronic device to a projector.

In setting, besides a part of the function keys (such as the keys “F1” to “F12”) displayed at the virtual keyboard, the virtual input interface may further includes a control option window, and the user can click the control option window to select a preset function to finish the setting.

The setting information of the input key is saved to the basic input/output system (BIOS) of the storage unit of the electronic device, and the setting information database in accordance with the input device is updated (step S2). The input device 1 is a keyboard as an example, and the setting information database in the embodiment is a scan code table.

When the electronic device boots, the updated setting information database is read. When the updated setting information database is read and the input key is activated, the setting function in accordance with the setting information is executed. In other words, when the electronic device boots, the updated setting information database is read via an embedded controller with a BIOS or the BIOS in the storage unit, and the setting function in accordance with the setting information is executed according to the updated setting information database. Thus, the set input keys can be directly used without entering an operation mode of the electronic device.

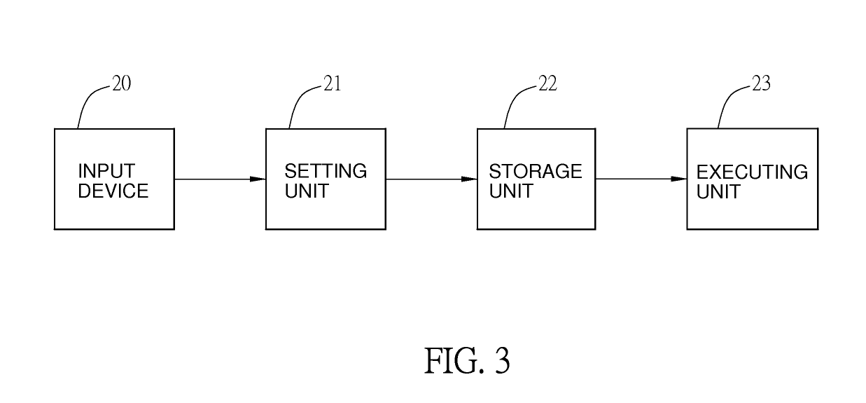

FIG. 3 is a block diagram showing a system which can define functions of an input device in an embodiment.

The system which can define the setting function of the input device can be applied to the electronic device in the previous embodiments, and it at least includes an input device 20, a setting unit 21, a storage unit 22 and an executing unit 23. The input device 20 includes at least one input key, and the storage unit 22 is electrically connected to the setting unit 21 and the executing unit 23, respectively. The setting unit 21, the storage unit 22 and the executing unit 23 may be software, firmware or hardware. The setting unit 21 further includes a virtual input interface, and the virtual input keys of the virtual input interface are configured in accordance with the input keys of the input device 20.

The setting unit 21 can define the setting information of the input key and generate a setting information signal. In setting, the user can set the setting information of the input key (which may be a null key or a press key) via a virtual input unit of the virtual input interface. When the user finishes the setting, the setting unit 21 converts the setting information to the setting information signal and transmits the signal to the storage unit 22. After the storage unit 22 received the setting information signal from the setting unit 21, a setting information database in accordance with the input device saved in the storage unit 22 is updated according to the setting information signal. Finally, the executing unit 23 reads the updated setting information database of the storage unit 22 and executes the corresponding setting information.

When the input key (the null key 11 or the press key 12) of the input device 1 is activated, the executing unit 23 reads the updated setting information database and executes the setting function in accordance with the setting information. The setting information database is saved in the BIOS of the storage unit 22.

Operating steps of other components are similar with those in the previous embodiments, which are omitted herein.

In sum, the virtual input interface of the electronic device allows the user to define any input key of the input device. As a result, one single input key can directly control or enable an additional function of the electronic device, and a damaged input key can be replaced by a spare null key.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method of custom-defined input function, applied to an electronic device, wherein the electronic device includes a virtual input interface and an input device, and the input device includes at least one input key, the method comprising following steps:
defining setting information of the input keys via the virtual input interface; and
saving the setting information of the input keys to a basic input/output system (BIOS) of the electronic device, and
updating a setting information database in accordance with the input device;
wherein when the updated setting information database is read and the at least one input key is activated, a setting function in accordance with the setting information is executed.

2. The method according to claim 1, wherein the at least one input key is a null key or a press key, the setting information of the null key is null, and the original setting information of the press key equips a function in accordance with the original setting function at an original state.

3. The method according to claim 1, wherein a layout of the virtual input keys of the virtual input interface is in accordance with that of the input keys of the input device.

4. The method according to claim 1, wherein the setting function designates the input keys as alphanumeric keys.

5. The method according to claim 1, wherein the setting function designates input keys as function keys.

6. The method according to claim 5, wherein the setting function of the function keys includes power control, status control, volume adjust, backlight adjust and display image switch.

7. The method according to claim 1, wherein the updated setting information database is read via the BIOS.

8. An electronic device with custom-defined input function comprising:
an input device including at least one input key;
a setting unit defining setting information of the input keys and generating a setting information signal;
a storage unit electrically connected to the setting unit to receive the setting information signal, and updating a setting information database in the storage unit in accordance with the input device according to the setting information signal; and
an executing unit electrically connected to the storage unit;
wherein when the input key is activated, the executing unit reads the updated setting information database and executes a setting function in accordance with the setting information, and the setting information database is saved in a BIOS.

9. The electronic device according to claim 8, wherein the input key is a null key or a press key, and at an original state, the setting information of the null key does not include any corresponding setting function, and the original setting information of the press key includes a corresponding original setting function.

10. The electronic device according to claim 8, wherein the setting unit, the storage unit and the executing unit are one of a software program, firmware and hardware.

11. The electronic device according to claim 8, wherein the setting unit further includes a virtual input interface.

12. The electronic device according to claim 11, wherein a layout of virtual input keys of the virtual input interface is in accordance with that of the input keys of the input device.

13. The electronic device according to claim 8, wherein the setting function designates the input keys as alphanumeric keys.

14. The electronic device according to claim 8, wherein the setting function designates the input keys as function keys.

15. The electronic device according to claim 14, wherein the setting function of the function key is one of power control, status control, volume adjust, backlight adjust and display image switch.
